(19) United States
(12) Patent Application Publication
(10) Pub. No.: US 2020/0138546 A1
(43) Pub. Date: May 7, 2020

(54) ORTHOTIC DEVICES & METHODS FOR TREATING COMPLICATIONS OF THE MASTICATORY NEUROMUSCULATURE

(71) Applicant: Richard D. Mohrlock, Vista, CA (US)

(72) Inventor: Richard D. Mohrlock, Vista, CA (US)

(21) Appl. No.: 16/183,621

(22) Filed: Nov. 7, 2018

(51) Int. Cl. A61C 7/08; A61C 7/36

(52) U.S. Cl. CPC A61C 7/08; A61C 7/36

(57) ABSTRACT

The disclosure concerns orthotic devices and related methods for treating complications of the masticatory neuromusculature, including, for example, temporomandibular disorder (TMD). In one aspect, the disclosure concerns an orthotic device for treating complications of the neuromusculature. In another aspect, the disclosure concerns a method for treating a patient experiencing complications of the neuromusculature. In yet another aspect, the disclosure concerns a method for: (i) finding a superior compressed position (SCP) of the jaw-joint, or a SCP range, wherein the neuromusculature is relaxed with the jaw-joint placed in the SCP range at least during occlusion, and (ii) designing one or more dental orthotic devices being configured to maintain the jaw within the SCP range during occlusion.

### BACKGROUND

### Field of the Invention

This invention relates to the field of dental orthotics; and more particularly, to oral orthotic devices and methods for treating complications of the masticatory neuromusculature.

### Description of the Related Art

The masticatory neuromusculature is the system of muscles and nerves involved in the action of breaking down food preparatory to deglutition. These muscles generally include: masseter, temporalis, medial pterygoid, and lateral pterygoid muscles. The masseter muscle is generally flat, thick and functionally equipped to close the jaw. Temporalis is a fan-shaped muscle also configured to close the jaw. The medial pterygoid parallels the masseter muscle (inside the jaw) and is configured to close the jaw. The lateral pterygoid opens the jaw, allows grinding side to side, and protrudes the mandible.

The mandible is generally described as having a body portion coupled to a ramus portion, and a mandibular condyle at each terminal end (right and left side). The mandibular condyles are situated in proximity to a zygomatic arch of the cranium forming a temporomandibular joint.

Occlusal interferences and incongruities in one's bite can cause hyperactivity in the masticatory neuromusculature. It is this hyperactivity that is the driving force that causes TMD, including but not limited to, grinding, inflammation and pain.

Temporomandibular disorder (TMD) is often a result of occlusal interferences, incongruities, and inflammation of the masticatory neuromusculature. It is important that the mandible is always treated as a suspension, and never as a lever. Any occlusal interference in a patient's bite can create a fulcrum that can stress the neuromusculature of the masticatory system. This distress produces hyper activity of the chewing muscles and is the most common cause of temporomandibular disorder (TMD).

There is a continued and unresolved need in the art for minimally invasive products and methods for treating complications of the masticatory neuromusculature, such as TMD.

### SUMMARY

The disclosure concerns oral orthotic devices and related methods for treating complications of the masticatory neuromusculature, including, for example, temporomandibular disorder (TMD).

In one aspect, the disclosure concerns an oral orthotic device for treating complications of the neuromusculature.

In an embodiment, the orthotic device comprises a plastic forming material shaped to form a shell, and a teeth-receiving cavity within the shell, the teeth-receiving cavity being configured to receive between eight and ten teeth of a patient therein, each of the between eight and ten teeth being one of: a central incisor, lateral incisor, cuspid or bicuspid of the patient. The volume of the shell extends between bicuspids of the patient when used, and effectively obviates any occlusal interferences posterior to the bicuspids (i.e., molars) such that grinding is prevented and the masticatory neuromusculature is relieved of stress, thereby healing pain and discomfort in the patient.

In another embodiment, the orthotic device comprises a plastic forming material shaped to form each of: a first shell portion, a second shell portion and a bridge extending therebetween; the first shell portion comprising a first terminal well and a first occlusal surface disposed adjacent to the first terminal well, the first terminal well configured to receive and nest with at least a first bicuspid of a patient; and the second shell portion comprising a second terminal well and a second occlusal surface disposed adjacent to the second terminal well, the second terminal well configured to receive and nest with at least a second bicuspid of a patient positioned at a side opposite the first bicuspid. The volume of the first and second shell portions extends between bicuspids of the patient when used, and effectively obviates any occlusal interferences posterior to the bicuspids (i.e., molars) such that grinding is prevented and the masticatory neuromusculature is relieved of stress, thereby healing pain and discomfort in the patient.

In yet another embodiment, the orthotic device can comprise a plastic forming material shaped to form a shell, and a teeth-receiving cavity within the shell, the teeth-receiving cavity being configured to receive all upper or lower teeth of a patient therein, characterized in that the shell comprises an occlusal surface opposite the teeth-receiving cavity, wherein a first protuberance is attached to the occlusal surface at a position adjacent to a first bicuspid at a first side (ex: left side), and wherein a second protuberance is attached to the occlusal surface at a position adjacent to a second and distinct bicuspid at a second side of a patient's bite. The first and second protuberances are configured to extend between bicuspids of the patient when the orthotic device is used, such that the device effectively obviates any occlusal interferences posterior to the bicuspids (i.e., molars) thereby preventing grinding of teeth, and the masticatory neuromusculature is thus relieved of stress, thereby healing pain and discomfort in the patient.

In another aspect, the disclosure concerns a method for treating a patient experiencing complications of the masticatory neuromusculature, the method comprises: (i) providing an orthotic device according to one of the embodiments as-described herein; and (ii) instructing the patient to wear the orthotic device for at least one-hour per day, and more preferably over-night.

Use of the orthotic device prevents excessive contraction of the masticatory muscles and obviates any occlusal interferences in the patient's teeth, thereby providing rest to these muscles, therapeutically relieving complications associated with TMD, and promoting healing of the masticatory neuromusculature.

In yet another aspect, the disclosure concerns a method for: (i) finding a “superior compressed position (SCP)” of the jaw-joint, or a range which encompasses the superior compressed position (herein the “superior compressed position range” or “SCP range”), wherein the neuromusculature is not overburdened or distressed with the jaw-joint configured in the superior compressed position range, and (ii) designing one or more dental orthotic devices being configured to maintain the jaw within the SCP range.

### BRIEF DESCRIPTION OF THE DRAWINGS

These and other features and benefits will be appreciated by one with skill in the art upon a thorough review of the appended detailed descriptions and drawings, wherein:

FIG. 1 shows human teeth including maxillary and mandibular bicuspids and anterior teeth. Molars are not illustrated.

FIG. 2 shows an orthotic device in accordance with a first embodiment, the device is configured to receive eight teeth of a patient including bicuspids and anterior teeth.

FIG. 3 shows another orthotic device in accordance with the first embodiment, the device is configured to receive ten teeth of a patient including bicuspids and anterior teeth.

FIG. 4 shows an alternative view of an orthotic device in accordance with the first embodiment.

FIG. 5 shows a top perspective view of an oral orthotic device in accordance with the first embodiment including first and second protuberances.

FIG. 6 shows a bottom perspective view of an oral orthotic device in accordance with the first embodiment including first and second protuberances.

FIG. 7 shows an orthotic device in accordance with a second embodiment.

FIG. 8 shows an oral orthotic device in accordance with a third embodiment, including protuberances configured at positions adjacent to bicuspids.

FIG. 9 is a flow-chart illustrating a method for treating complications of the masticatory neuromusculature in a patient.

FIG. 10 shows a physical model of a patient's bite built within an articulator using casting and models of the patient's bite.

FIG. 11 shows an articulator holding a model of the patient's bite which is configured to obtain data related to the patient's superior compressed position of his or her jaw-joint.

### DETAILED DESCRIPTION OF EMBODIMENTS

In the following description, for purposes of explanation and not limitation, details and descriptions are set forth in order to provide a thorough understanding of the embodiments of the invention. However, it will be apparent to those skilled in the art that the present invention may be practiced in other embodiments, including certain variations or alternative combinations that depart from these details and descriptions. The illustrated examples are intended to enable those with skill in the art to practice the invention, but such examples shall not reasonably be construed as limiting the spirit and scope of the invention as-claimed.

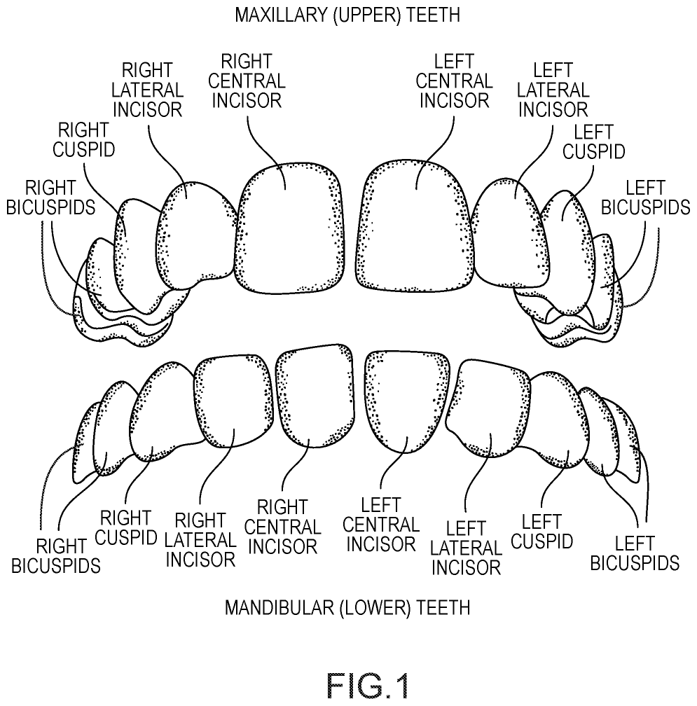

For purpose of clarity and definition as it relates to the present disclosure, FIG. 1 shows human teeth including maxillary and mandibular bicuspids and anterior teeth, such as central incisors, lateral incisors, cuspids, and bicuspids. While bicuspids may be referred to in the art as “pre-molars”, for purposes herein bicuspids are explicitly differentiated and are not molars.

### Oral Orthotic Device

In one aspect, an oral orthotic device is provided for treating complications of the masticatory neuromusculature.

A key aspect of the invention is providing an oral orthotic device which obviates occlusal interferences posterior to the bicuspids. This can be accomplished, generally, with one of two solutions, including:

(i) providing an oral orthotic device which covers left and right-side bicuspids and up to all of a patient's anterior teeth (forward of the bicuspids) but covers none of the molars such that the patient's bite occlusion occurs at the bicuspids where the shell of the device ends, i.e. no volume of the device extends over molars resulting in occlusion at the bicuspids; or

(ii) providing an oral orthotic device which covers any number of the patient's teeth but is specifically designed with added volume to form first and second protuberances, including one of the first and second protuberances being configured for placement between upper and lower bicuspids at a left-side of the patient's bite, and the other of the first and second protuberances being configured for placement between upper and lower bicuspids at a right-side of the patient's bite, wherein the patient's occlusion when wearing the oral orthotic device occurs concurrently at each of the first and second protuberances (at the bicuspids).

In a preferred embodiment, an oral orthotic device, comprises: a plastic forming material shaped to form a shell, and a teeth-receiving cavity extending within the shell, the teeth-receiving cavity being configured to receive between eight and ten teeth of a patient therein, each of the between eight and ten teeth being one of: a central incisor, lateral incisor, cuspid or bicuspid of the patient. In other words, in the preferred embodiment the teeth-receiving cavity does not receive a molar of the patient therein. Should a molar be received in the orthotic device, the portion of the device capturing the molar would tend to act as a fulcrum and would likely result in the agitation of the masticatory neuromusculature.

The plastic forming material as referenced herein may be any thermoforming or pressure forming material suitable for the manufacture of dental orthotics. For example, the plastic forming material may comprise a “thermoplastic”, such as “clear splint biocryl” (available from Great Lakes Orthodontics, https://www.greatlakesortho.com), which is a polyethylene terephthalate glycol-modified (PETG) copolymer. Alternatively, the plastic forming material may comprise a three-dimensional (3D) printing material, such as a PETG polymer filament, or any similar material or filament which can be used in combination with heat or pressure to form a dental orthotic. Still further, the plastic forming material may comprise a light-cured material, such as an ultraviolet light cured plastic. One having skill in the art will recognize a large number of materials suitable for the purpose of forming a dental orthotic device, which materials are intended to be incorporated herein via the ordinary level of knowledge and skill in the art.

For added rigidity, the orthotic device can be fabricated with a plastic forming material and may further comprise a coating applied to at least a portion of the shell. In various preferred embodiments, the coating may comprise an acrylic coating.

Additionally, and/or alternatively, the acrylic coating may be applied at a surface of the shell opposite the bicuspid-receiving wells of the orthotic device, thereby forming first and a second protuberances of the orthotic device (for occluding with opposing bicuspids), wherein the acrylic coating functions, inter alia, to provide added volume to the orthotic device between the natural mating of the patient's bicuspid teeth on occlusion. In some embodiments, the volume of the first and second protuberances is determined to be sufficient to place the patient's jaw-joint within a range of the superior compressed position as further described herein.

In various embodiments, the teeth-receiving cavity may consist of between eight and ten wells, each of the wells being independently configured to nest one of the between eight and ten teeth of the patient therein. In this regard, each well is adapted to receive a corresponding tooth of the patient's bite. A combination of the wells defines the teeth-receiving cavity. Where the teeth-receiving cavity of the orthotic device is configured to receive between eight and ten teeth, there should be a corresponding number of wells for each tooth received, though it is recognized that some patients may not possess one or more natural teeth.

Where a patient is missing a tooth, the device can be modified with fewer wells in the teeth-receiving cavity to address the bite of the particular patient, but maintaining the goal of creating occlusion at the patient's bicuspids. Alternatively, a well may be implemented where no tooth will be received if the corresponding tooth is not present.

As discussed above, in certain embodiments the oral orthotic device may comprise a build-up layer applied to at least a portion of the shell. It is preferred that the build-up layer be disposed along the occlusal path between bicuspids (not molars). The build-up layer may comprise acrylic. In some embodiments, the orthotic device may comprise two or more build-up layers each forming a protuberance, respectively. For example, with an orthotic device configured to receive maxillary teeth, a first build-up layer may be implemented to yield a first protuberance disposed adjacent to a left bicuspid, and a second build-up layer may be implemented to yield a second protuberance adjacent to a right bicuspid of the patient. In this regard, the oral orthotic device may comprise a first protuberance and a second protuberance, the first protuberance being disposed adjacent to first terminal well, and the second protuberance being disposed adjacent to the second terminal well of the oral orthotic device.

The protuberance s can be adjusted by sanding, abrading or melting techniques such that the first and second protuberances may be configured to concurrently touch opposing bicuspids on each of the left and right sides upon occlusion (bite-down). Additionally, modifications and adjustments can be implemented in order to create a desired volume of the protuberances such that the patient's jaw-joint may be configured within an acceptable range of the superior compressed position upon occlusion.

An acceptable range is any range which is near enough the superior compressed position to achieve reduced stress. More specifically, the range is within 5.0 mm in any radial direction from the superior compressed position, and more preferably within 2.0 mm therefrom. The range of the superior compressed position (SCP) can be appreciated using an articulator and models of the patient's teeth, wherein the model is fitted with paper discs as described herein. Other modes for appreciating the SCP may include virtual simulation and other techniques known to one with skill in the art.

In some embodiments, the teeth-receiving cavity consists of between eight and ten wells, each of the wells being independently configured to receive and nest one of the between eight and ten teeth of the patient therein; particularly wherein each of the between eight and ten teeth is one of: a central incisor, lateral incisor, cuspid or bicuspid of the patient.

The teeth-receiving cavity may further comprise: a first terminal well and a second terminal well, wherein one of the first and second terminal wells is configured to receive a left-bicuspid of the patient, and wherein the other of the first and second terminal wells is configured to receive a right-bicuspid of the patient therein.

While the oral orthotic device may preferably be configured to receive and nest maxillary teeth of the patient; the oral orthotic device may alternatively be configured to receive and nest mandibular teeth of the patient.

Now, turning to the illustrated embodiments.

### First Embodiment: Device Holds Eight to Ten Teeth

In a first embodiment, the orthotic device generally comprises: a plastic forming material shaped to form a shell and a teeth-receiving cavity within the shell, the teeth-receiving cavity being configured to receive between eight and ten teeth of a patient therein, wherein each of the between eight and ten teeth is one of: a central incisor, lateral incisor, cuspid or bicuspid of the patient.

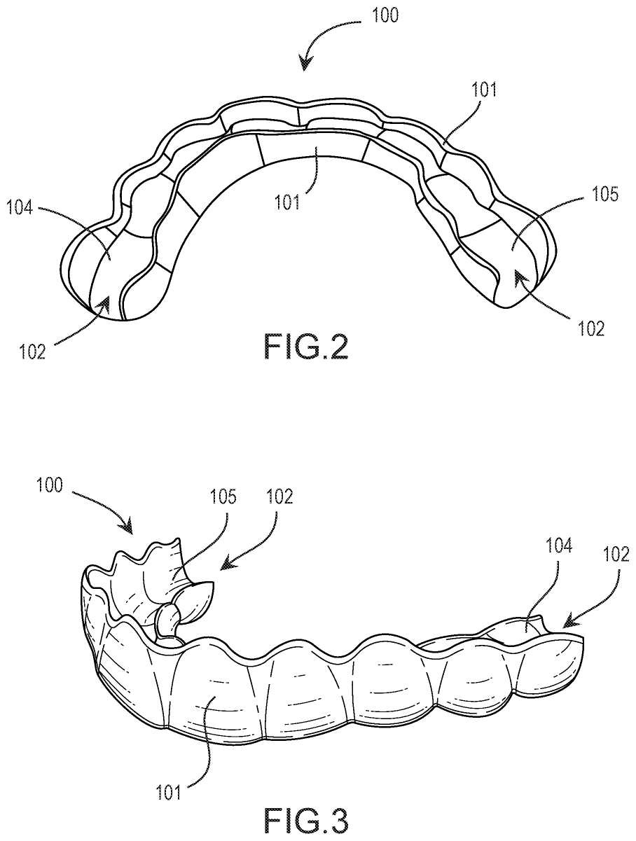

FIGS. 2-4 show an oral orthotic device in accordance with the first embodiment.

As shown in FIG. 2, the oral orthotic device 100 is configured to receive and nest eight teeth of a patient, each of the eight teeth being one of: a central incisor, lateral incisor, cuspid or bicuspid of the patient.

In contrast, the oral orthotic device 100 shown in FIG. 3 is configured to receive and nest ten teeth of a patient.

In each embodiment as shown in FIG. 2 and FIG. 3, the oral orthotic device is configured to receive and nest between eight and ten teeth of a patient. The number of teeth, i.e. between eight and ten teeth, is significant because this is the number of teeth anterior to and including the bicuspids. As disclosed above, a goal of the invention is to prevent or obviate occlusal interferences posterior to the bicuspids as these occlusal interferences can create a fulcrum which results in inflammation and pain in the masticatory neuromusculature. Creating volume (i.e. the device shell) between bicuspids, results in occlusion only at the bicuspids, thereby removing any fulcrum created posterior to the bicuspids and relieving complications of the masticatory neuromusculature. By creating an occlusion at the bicuspids, the patient's jaw-joint can find the superior compressed position (SCP), or SCP range, upon such occlusion, which over time provides therapeutic benefits, such as reducing stress-induced inflammation and pain.

As further shown in FIG. 2, the oral orthotic device comprises a plastic forming material shaped to form a shell 101 and a teeth-receiving cavity 102 extending within the shell. The teeth-receiving cavity extends from a first terminal well 104 to a second terminal well 105, wherein the first terminal well is configured to receive and nest a left-bicuspid and wherein the second terminal well is configured to receive a second bicuspid of the patient.

Similarly, FIG. 3 further shows the oral orthotic device comprises a plastic forming material shaped to form a shell 101 and a teeth-receiving cavity 102 extending within the shell. The teeth-receiving cavity extends from a first terminal well 104 to a second terminal well 105, wherein the first terminal well is configured to receive and nest a left-bicuspid and wherein the second terminal well is configured to receive a second bicuspid of the patient. Again, here is shown a device configured to receive ten teeth of a patient.

Generally, the plastic forming material is formed about a model of a patient's teeth using heat, pressure, or a combination thereof, followed by a cooling step to cure the formed shell of the oral orthotic device, wherein cooling can be achieved using any combination of water, ice, and/or air. In this regard, it is preferred to select a plastic forming material that has a melt temperature sufficiently above ambient temperature to avoid deformation when the patient is wearing the oral orthotic device.

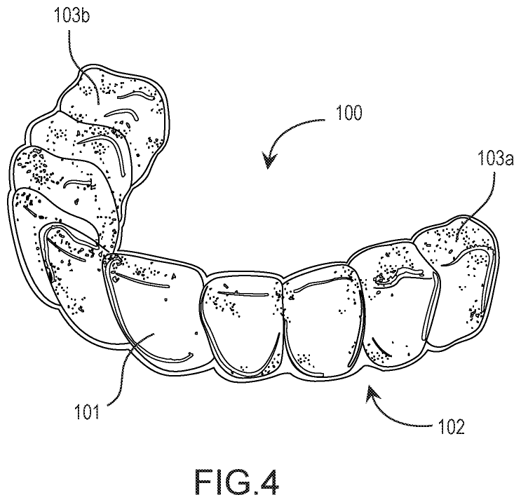

FIG. 4 shows another view of the oral orthotic device 100 of FIG. 3, wherein the shell of the device comprises one or more occlusal surfaces 103a; 103b, each disposed on a surface of the shell portion 101 opposite the teeth-receiving cavity 102.

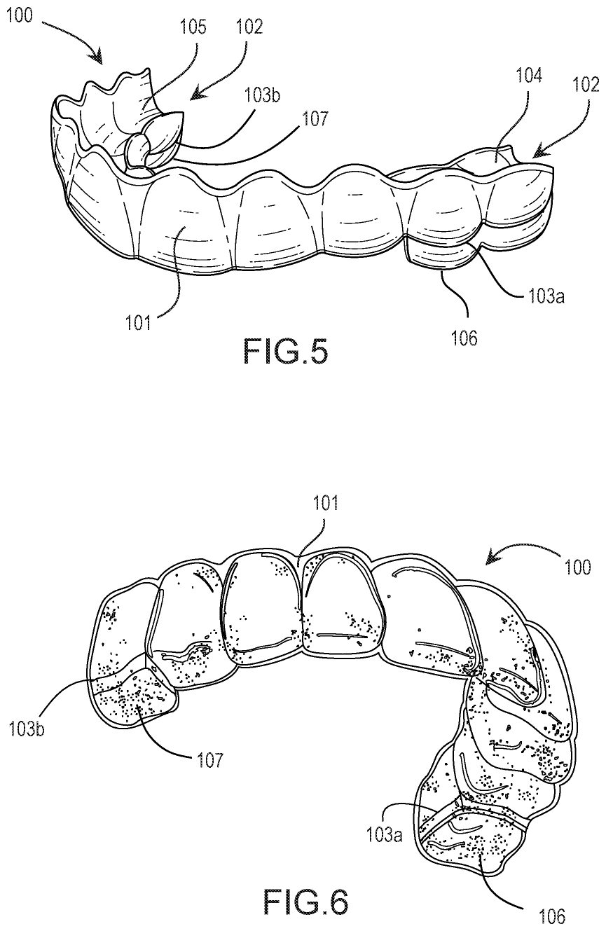

FIGS. 5-6 show an oral orthotic device similar to that illustrated in FIGS. 2-4, but with optional build-up layers forming first and second protuberances.

Referring to FIG. 5, an oral orthotic device 100 is shown with optional first protuberance 106 extending from the shell 101 at the occlusal surface 103a (surface of the shell opposite the teeth-receiving cavity and adjacent to the bicuspid-receiving first terminal well 104). In addition, the device is shown with second protuberance 107 which is applied to the shell, also at a side opposite the teeth-receiving cavity and adjacent to the bicuspid-receiving second terminal well 105. The second protuberance 107 extends from second occlusal surface 103b.

Each of the protuberances may be formed by applying one or more layers of acrylic, or other build-up material appreciated by one with skill in the art, to the shell at the respective occlusal surfaces adjacent to the bicuspids. For example, an acrylic or similar material suitable for manufacturing dental orthotic devices can be applied to the shell and allowed to cure. The acrylic can be applied to the entire shell as a build-up layer, or may be applied to one or more site-specific portions thereof, such as at a position adjacent to a bicuspid-receiving well as shown. This provides added strength, and more importantly, added volume to the oral orthotic device at the bicuspids for adjusting the patient's bite occlusion when the device is worn. The volume of the build-up layer(s) and protuberances can be modified by abrasive removal, sanding, melting or other processes known to one having skill in the art in order to modify a thickness (volume) of the respective build-up layer(s) or protuberances. For purposes herein, abrasive paper may be a preferred means for adjusting the thickness of the build-up layer(s) and/or protuberances.

FIG. 6 shows another view of the oral orthotic device of FIG. 5 with protuberances 106; 107, respectively.

### Second Embodiment: Device Holds Bicuspids Only

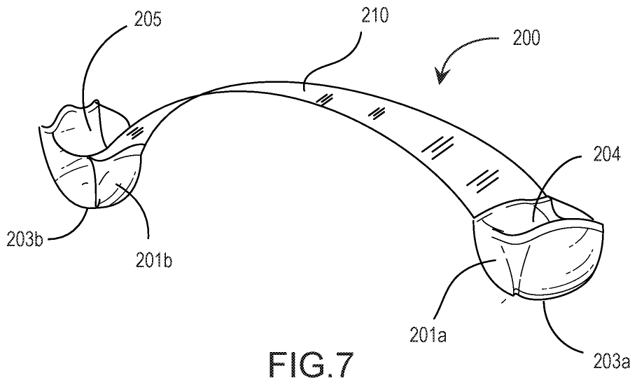

FIG. 7 shows an orthotic device 200 in accordance with a second embodiment, wherein the device generally comprises a plastic forming material shaped to form each of: a first shell portion 201a, a second shell portion 201b and a bridge 210 extending therebetween. The first shell portion comprises a first terminal well 204 and a first occlusal surface 203a disposed adjacent to the first terminal well, wherein the first terminal well is configured to receive and nest at least a first bicuspid of a patient (though it may receive two adjacent bicuspids). The second shell portion comprises a second terminal well 205 and a second occlusal surface 203b disposed adjacent to the second terminal well, wherein the second terminal well is configured to receive and nest with at least a second bicuspid of the patient (or adjacent bicuspids). One of the first and second bicuspids is a left-bicuspid, and the other of the first and second bicuspids is a right-bicuspid in accordance with FIG. 1.

In this regard, a similar oral orthotic device is provided to that of FIGS. 2-6, above, but wherein the anterior teeth are not received and nested within the device. The first and second shell portions provide volume between bicuspids of the patient, similarly circumventing any occlusal interferences located posterior to the bicuspids in the patient's natural bite.

As appreciated from the embodiment of FIG. 7, the oral orthotic device 200 is configured to receive one left and one right bicuspid of the patient. However, with slight modification the device can receive two adjacent left-bicuspids, and two adjacent right-bicuspids of the patient. The anterior teeth forward of the bicuspids, and the posterior teeth behind the bicuspids are generally not received by the device in this embodiment. As such, the volume of the device itself provides material which causes occlusion of the patient's bite at the bicuspids of the patient when worn.

Optionally, one or more layers of acrylic or other material may be applied as described herein. Additionally, the layers of acrylic or other material may form protuberances at the occlusal surfaces 203a; 203b or the device. The protuberances can be modified or adjusted to provide a volume configured to place the jaw-joint of the patient in the superior compressed position upon occlusion.

The device of FIG. 7 can be fabricated similarly to the devices in FIGS. 2-6, described above. For example, by forming a shell over a model of the patient's bite, plastic formed at area corresponding to the roof of the patient's mouth can be used as the bridge, and plastic formed over the bicuspid(s) is used to form the first and second shells of the device. Other material can be removed.

It should be noted that a model of the patient's bite can be made using conventional techniques, such as obtaining impressions and making molds from the impressions to form models. Alternatively, digital scanning and modeling techniques coupled with three-dimensional printing may be used to form molds from which models can be cast. Alternatively, the models can be 3D printed from virtual models.

Still further, three-dimensional printing may be used in conjunction with digital models to form the oral orthotic device itself.

In each of the variations illustrated in FIGS. 2-7, an oral orthotic device is provided with no volume extending behind the bicuspids (no volume at the molars), thereby circumventing any occlusal interferences the patient may naturally experience posterior to the bicuspids. With this in mind, the patient's bite (wearing of teeth) can be protected, effectively obviating obstructions during wear, such that no fulcrum or occlusal interferences are experienced posterior to the bicuspids during occlusion, and the masticatory neuromusculature can be relieved.

With normal wear of the oral orthotic device in any of these or similar embodiments, such as overnight wear, the masticatory neuromusculature may heal, related swelling and inflammation can be reduced, and pain associated with complications of the masticatory neuromusculature is generally relieved.

In each of the first and second embodiments herein, the orthotic device is distinguished from conventional mouth pieces by at least the feature that the teeth-receiving cavity does not receive a molar of the patient therein. For purposes herein, a bicuspid, though often referred to in the art as a “pre-molar”, shall not comprise a “molar” and the orthotic device in the first and second embodiments may receive a bicuspid but not a molar.

### Third Embodiment: Full Mouthpiece with Protuberances

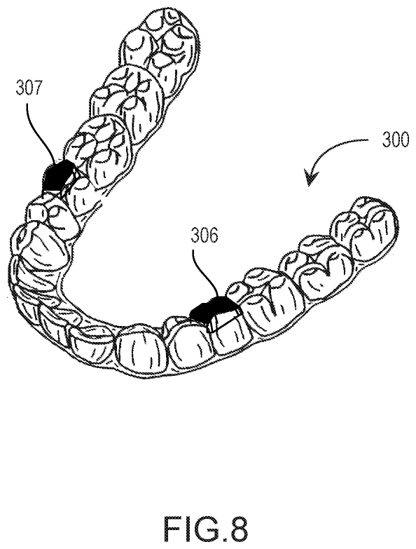

In yet another embodiment, as illustrated in FIG. 8, an oral orthotic device can be provided which comprises a shell 301 and a teeth-receiving cavity confined by the shell, wherein the teeth-receiving cavity is configured to receive up to all of the teeth of a patient. To obviate a fulcrum which may be created by the shell, and which extends posterior to the bicuspids, material is applied at the occlusal surfaces of the shell at a position adjacent to the bicuspids, thereby forming first and second protuberances 306; 307, respectively, wherein one of the first and second protuberances is configured to be disposed between the patients left-bicuspids (upper and lower), and wherein the other of the first and second protuberances is configured to be disposed between the patients right-bicuspids (upper and lower). The orthotic device is preferably adjusted, with abrasive sheet sanding or otherwise, such that the left- and right-sides of the patient's bite concurrently occlude (touch at the same time) with the device being worn. In addition, the volume of the protuberances can be configured such that the patient's occlusion occurs with the jaw-joint being placed in the superior compressed position, or within an acceptable range thereof for reducing stress on the masticatory neuromusculature.

### Method for Treating Complications of the Masticatory Neuromusculature

In another aspect, a method for treating complications of the masticatory neuromusculature comprises the steps:

(i) providing an oral orthotic device, the oral orthotic device comprising:

(ii) a plastic forming material shaped to form a shell and a teeth-receiving cavity extending within the shell, the teeth-receiving cavity being configured to receive between eight and ten teeth of a patient therein, each of the between eight and ten teeth being independently selected from the group consisting of: a central incisor, a lateral incisor, a cuspid, and a bicuspid of the patient;

(iii) a plastic forming material shaped to form each of: a first shell portion, a second shell portion and a bridge extending therebetween, the first shell portion comprising a first terminal well and a first occlusal surface disposed adjacent to the first terminal well, the first terminal well configured to receive and nest with at least a first bicuspid of a patient, and the second shell portion comprising a second terminal well and a second occlusal surface disposed adjacent to the second terminal well, the second terminal well configured to receive and nest with at least a second bicuspid of a patient; or

(iv) a shell portion shaped to form a teeth-receiving cavity and an occlusal surface opposite the teeth-receiving cavity, wherein the teeth-receiving cavity is configured to receive and nest teeth of a patient, characterized in that the oral orthotic device further comprises: a first protuberance extending from the occlusal surface adjacent to a left-bicuspid, and a second protuberance extending from the occlusal surface adjacent to a right-bicuspid, wherein each of the first and second protuberances are configured to concurrently touch an opposing bicuspid upon occlusion of the patient's bite; and

(v) instructing the patient to wear the orthotic device.

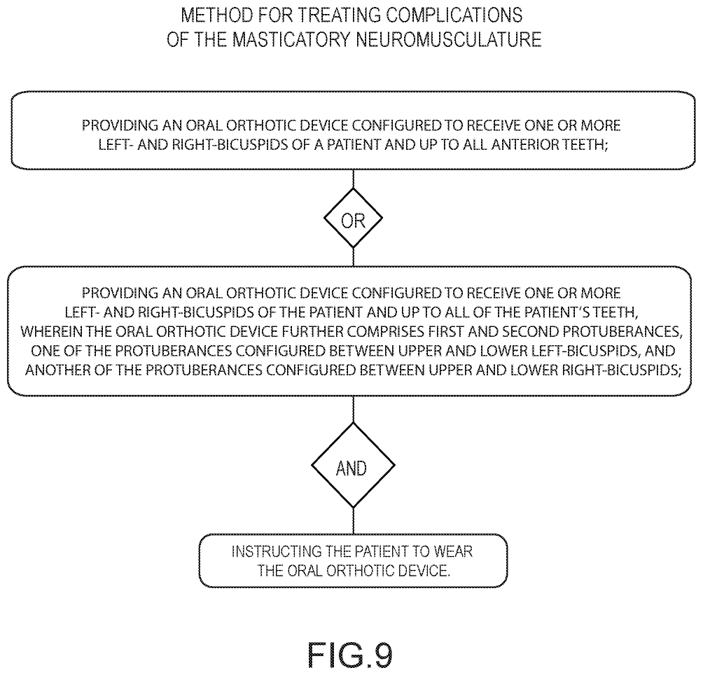

Accordingly, and more simply, in a preferred embodiment as illustrated in FIG. 9, the method for treating complications of the masticatory neuromusculature may comprise the steps of:

(i) providing an oral orthotic device configured to receive one or more left- and right-bicuspids of a patient and up to all of the patient's anterior teeth; or

(ii) providing an oral orthotic device configured to receive one or more left- and right-bicuspids of the patient and up to all of the patient's teeth (possibly including molars), wherein the oral orthotic device further comprises first and second protuberances, one of the first and second protuberances configured for positioning between the patient's upper and lower left-bicuspids on occlusion, and another of the first and second protuberances is configured for positioning between the patient's upper and lower right-bicuspids on occlusion; and

(iii) instructing the patient to wear the oral orthotic device, preferably overnight.

### Superior Compressed Position, Range & Designing Oral Orthotic Devices Compatible Therewith

In yet another aspect, the disclosure concerns a method for: (i) finding a “superior compressed position (SCP)” of the jaw-joint, or a range which encompasses the superior compressed position (herein the “superior compressed position range” or “SCP range”), wherein the neuromusculature is not overburdened or distressed with the jaw-joint configured in the superior compressed position range during occlusion, and (ii) designing one or more dental orthotic devices or implants being configured to maintain the jaw within the SCP range at occlusion.

The superior compressed position of the jaw-joint is important, because, during occlusion this is the position where the jaw-joint wants to go, so long as no obstructions are present. At the SCP, the least amount of stress is applied to the masticatory neuromusculature. Unfortunately, when occlusal interferences distract the jaw and force occlusion with the jaw joint being positioned outside the SCP range, in a torqued or otherwise distressed manner, inflammation and pain can develop.

For this reason, practitioners should design orthotics and implants, such as aesthetic corrective orthotics, for example, INVISALIGN, as well as dentures, and the like, with the SCP in mind. Many practitioners are finding an end point of a corrective program based on aesthetics alone, but significant problems can occur if the SCP is not achieved at occlusion, or given adequate consideration. For example, while teeth may be shifted to close gaps and adjust orientation for straight teeth in order to improve aesthetics, it is possible, and often likely, for an aesthetic program to cause occlusal interferences in the patient's bite, which may create an unwanted fulcrum, and may result in grinding, inflammation and/or pain.

As such, herein is proposed a method for finding the SCP of the jaw-joint for purposes of designing an end point in such corrective procedures, and other dental applications.

The method for finding the SCP, or SCP range, can be practiced mechanically or virtually.

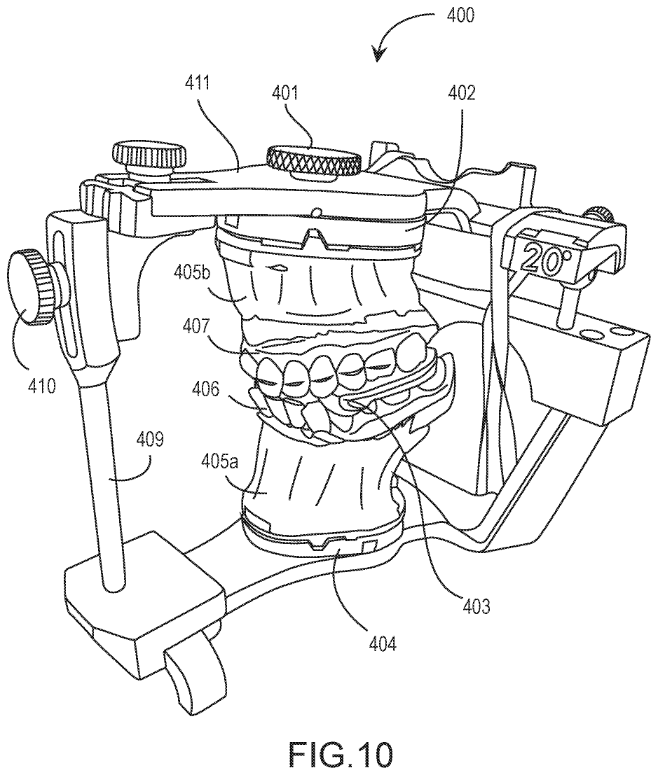

In a mechanical embodiment, as illustrated in FIG. 10, the method begins with obtaining a model 406; 407 of the patient's teeth. To obtain a model of the teeth, impressions of the upper and lower teeth may be acquired. A dental impression is a negative imprint of hard (teeth) and soft tissues in the mouth from which a positive reproduction (cast or model) can be formed. It is made by placing an appropriate material in a stock or custom dental impression tray which is designed to roughly fit over the dental arches. One with skill in the art is generally familiar with conventional methods for acquiring dental impressions and making a cast or model of teeth from the impressions, and as such, details, which are commonly known, will not be further described herein.

The skilled practitioner will also acquire a plurality of wax records 403. The wax records are preferably obtained during the same visit with the patient at which the impressions or three-dimensional image of the teeth is acquired, though this can be accomplished in a subsequent visit, and the wax records may be obtained at any time. Wax records are generally obtained by inserting a wax strip into the occlusal plane within the mouth of a patient, and occluding the teeth into the wax strip. While any wax can be used to obtain wax records, MILTEX® wax manufactured by Integra York Pa., Inc., of York, Pa., is one suitable choice. While wax is preferred, other similar materials may be implemented to achieve the same or substantially the same results.

In one embodiment, it may be preferred to fold a wax sheet over itself, forming a thicker front-side of the wax record, and heat the rear side slightly to reduce modulus at the rear side of the wax record. Care should be taken so that the teeth do not completely penetrate the wax record, or the bite should only partially extend into the wax.

In another embodiment, a wax record may be provided with a modulus gradient varying from rear to front-side of the wax record, wherein the rear side comprises a softer modulus such that a fulcrum is not created at the rear-side of the wax record. This can be accomplished by forming a wax block from a plurality of layers, each layer comprising an independent modulus associated therewith, wherein the modulus varies from softer to increasingly rigid, curing the wax block to form a monolithic piece (generally using heat, pressure, or a combination thereof) and sectioning the wax block to provide sheets of wax having variable modulus from a first side to a second side opposite the first side (i.e. rear to front side of the wax record formed therefrom).

Other techniques for forming wax records having a variable modulus may be appreciated by one with skill in the art.

The plurality of wax records obtained from the patient may include two, three, four or any greater number of records. The multiple wax records will be later used to register congruent alignment of the upper and lower models in an articulator 400 for replicating the patient's bite. The wax records may include indicia, such as but not limited to: patient identification marks (initials, name, ID number, etc.), date wax records were obtained, and iteration (“1 of 3”; “No. 1”; etc.). Any combination of indicia may be implemented.

One of the lower and upper models 406; 407, respectively, of the patient's teeth should be attached to a corresponding portion of an articulator, generally accomplished with the use of plaster 405a; 405b. While many articulators are available and may be implemented, the DENAR® Automark Non-Adjustable Articulator (http://whipmix.com) may be preferred. For example, a generic block can be placed in the articulator, and the upper model of the patient's teeth rested on the generic block. A first mounting plate 402 is attached to the upper portion 411 of the articulator 400, and plaster 405b is used to attach the upper model 407 to the first (upper) mounting plate 402. The upper model and first mounting plate are further connected to the articulator using a lock-screw 401 or another securing feature.

The generic block is removed, and the lower model 406 is introduced by mating with the upper model using one of the wax records 403. A second mounting plate 404 is connected to the lower portion of the articulator, and plaster 405a is used to attach the lower model to the second mounting plate within the articulator. Note that the articulator may be oriented upside-down while the lower model is attached to the second mounting plate. The lower model, plaster, and second mounting plate remain attached to the articulator via a screw or other securing feature with the lower model being in a position corresponding to the patient's bite using one of the wax records previously obtained. It should be further noted that the wax record having two sides, one side corresponding to the upper teeth and another side corresponding to the lower teeth, should be carefully placed to ensure the correct side and teeth of the models are matched. Each of the upper model 407, lower model 406, and the wax record 403 placed therebetween should align or be “congruent” within the articulator before the model is tightened or set in the articulator.

While the upper model is installed in the articulator first, and the lower model second in the above-described technique, it will be recognized that the lower model may be installed within the articulator first with minor rearrangement of the above steps in order to accomplish the same goal of placing the upper and lower models within the articulator.

An incisal guide pin 409 can be adjusted using an incisal pin adjustment screw 410 such that incisal guide pin is configured to touch the bottom portion of the articulator with the wax record in place. Now, as the was record is removed from the model, the wax record occlusion (no occlusal interferences in this position) can be observed in the articulator.

Next, the other wax records can be checked using the articulator and mounted upper and lower models to ensure congruency.

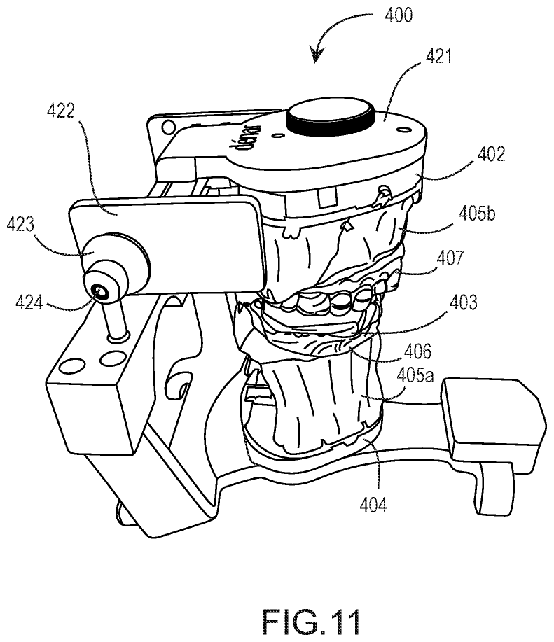

Now referring to FIG. 11, a distinct upper articulator mount 421 having planar tabs 422 on each of a left and right side, is attached to the combination of the first mounting plate 402, plaster 405b, and upper model 407, collectively an “upper model assembly”, and the upper model assembly is placed with the lower model assembly (lower model 406, plaster 405a, and second mounting plate 404) in the articulator 400. The planar tabs can accept paper discs 423 (stickers) on each of the left and right sides, and the paper discs can be marked at an equivalent of the intercondylar axis of the articulator, through holes 424 at the articulator joint, using a marking implement.

To verify congruency, each of the wax records is inserted and the models translated to occlusion within the articulator. The intercondylar axis is marked using the paper discs and marking implement to identify an intercondylar rotation axis as approximated with each of the wax records in place. In this regard, the condylar positions and approximated intercondylar rotation axes are analyzed in the articulator according to the model of the patient's teeth with each wax record and paper disc. For each wax record installed in the model, a distinct paper disc is marked thereby creating data associated with the intercondylar rotation axis and each wax record. Alternatively, the same paper disc may be marked for each wax record to compare markings. Whether using the paper discs or another technique, the data associated with the condylar positions and approximated intercondylar axes is recorded. The wax record providing the most forward and highest mark on the paper disc, relative to the articulator, provides the wax record which places the model closest to the superior compressed position at the simulated occlusion within the articulator (taking into consideration the wax record, which obviates occlusal interferences), and is therefore the “selected wax record” which places the model closest to the SCP.

Now, ensuring the incisal guide pin is configured to touch the bottom portion of the articulator with the selected wax record installed, the selected wax record in the articulator is removed and a space between the bicuspids is determined. This space between the upper and lower bicuspids is required to be maintained in order for the patient's jaw-joint to be configured in the SCP, or range thereof, within the articulator.

A dental orthotic may then be fabricated from the model(s) which replicates the spacing between the bicuspids in the model. In other words, once the superior compressed position is discovered in the model, the next step is to fabricate a device which accomplishes an occlusion that simulates the same spacing or gap between bicuspids. The DENAR articulator referenced above provides a suitable incisal guide pin which can be adjusted to preserve the desired gap with the models in the SCP.

An oral orthotic device can now be fabricated from one of the upper and lower models according to any embodiment described herein.

The oral orthotic device is placed (installed) on the model it was fabricated from, and re-inserted into the articulator with the incisal pin holding the same configuration having the desired gap. The oral orthotic device may then receive one or more build-up layers of acrylic or similar material to span the gap between the bicuspids, the build up layers can form the protuberances as described herein. Using the articulator, and the incisal pin thereof in the desired configuration, the articulator is used to modify the oral orthotic device, using abrasive paper or other means, such that the simulated occlusion (using the articulator) brings both sides of the bite to touch at a mating of the bicuspids and the oral orthotic device. Several modifications may be required of the oral orthotic device, such as applying build-up layers and taking down volume with abrasive paper, until the oral orthotic device is properly dimensioned for simultaneous left and right-side occlusion at the bicuspids within the articulator.

It is important that the left and right sides touch concurrently (at the same time) as any one side touching before the other may indicate possible torque applied to the jaw-joint.

Next, the patient is invited back, and the oral orthotic device is applied to the patient's teeth. The patient is asked to bite down to occlusion, informing the practitioner whether any side, left or right-side, touches first. Based on information provided by the patient, the practitioner refines the oral orthotic device by lightly taking down volume of the device at the side that touches first, and this process is repeated until the patient concurrently occludes both sides of the bite at the bicuspids.

Now, while the above-described oral orthotic device is useful for relieving pain and reducing inflammation of the masticatory neuromusculature, it should be noted that other orthotics, such as dentures, and cosmetic or aesthetic corrective devices can similarly be fabricated with protuberances that cause the patient's occlusion to occur concurrently at left- and right-bicuspids, such that the SCP position, or a position within the SCP range, can be accomplished at the jaw-joint, thereby preventing or correcting complications, such as grinding, inflammation and pain.

Additionally, while a physical method has been described, it is contemplated that the same or similar result may be achieved by digital means. For example, instead of impressions and cast models, a digital scan and three-dimensional model (virtual model) may be obtained. From the virtual model can be 3D-printed either physical models (for forming an orthotic device) or the orthotic device itself.

The virtual model can be articulated in the virtual environment (using software) as opposed to using a physical articulator. Or the virtual model can be used merely to produce a model or the oral orthotic device, and the physical articular can be otherwise implemented to perform one or more steps in accordance with the methods disclosed herein.

In some embodiments, the wax records can be scanned into the virtual environment in order to check congruency using software and virtual steps.

The patient's SCP can be discovered using physical techniques, virtual techniques, or a combination.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### REFERENCE SIGNS LIST

oral orthotic device (100; 200; 300)
shell (101; 301)
teeth-receiving cavity (102)
first occlusal surface (103a; 203a)
second occlusal surface (103b; 203b)
first terminal well (104; 204)
second terminal well (105; 205)
first protuberance (106; 206; 306)
second protuberance (107; 207; 307)
first shell portion (201a)
second shell portion (201b)
bridge (210)
articulator (400)
lock-screw (401)
first (upper) mounting plate (402)
wax records (403)
second mounting plate (404)
plaster (405a; 405b)
lower model (406)
upper model (407)
incisal guide pin (409)
incisal pin adjustment screw (410)
upper portion of the articulator (411)
upper articulator mount (421)
planar tabs (422)
paper discs (423)
holes (424)

1. An oral orthotic device (100), comprising:
a plastic forming material shaped to form a shell (101) and a teeth-receiving cavity (102) extending within the shell, the teeth-receiving cavity being configured to receive between eight and ten teeth of a patient therein, each of the between eight and ten teeth being independently selected from the group consisting of: a central incisor, a lateral incisor, a cuspid, and a bicuspid of the patient; and
one or more build-up layers (103) applied to at least a portion of the shell.

2. The oral orthotic device of claim 1, wherein the teeth-receiving cavity is adapted to not receive a molar of the patient therein.

3. The oral orthotic device of claim 1, wherein the plastic forming material comprises a thermoplastic material.

4. The oral orthotic device of claim 3, wherein the thermoplastic material comprises polyethylene terephthalate glycol (PETG) copolyester.

5. (canceled)

6. The oral orthotic device of claim 1, wherein the one or more build-up layers comprises acrylic.

7. The oral orthotic device of claim 1, comprising two or more build-up layers, each of the two or more build-up layers being applied to at least a portion of: the shell, or another of the build-up layers.

8. The oral orthotic device of claim 1, wherein the one or more build-up layers form each of a first protuberance and a second protuberance, each of the first and second protuberances extending from an occlusal surface of the shell at a side opposite the teeth-receiving cavity, the first protuberance being configured for placement adjacent to a left-bicuspid of the patient, and the second protuberance being configured for placement adjacent to a right-bicuspid of the patient.

9. The oral orthotic device of claim 1, wherein the teeth-receiving cavity consists of between eight and ten wells, each of the wells being independently configured to receive and nest one of the between eight and ten teeth of the patient therein.

10. The oral orthotic device of claim 1, the teeth-receiving cavity further comprising: a first terminal well (104) and a second terminal well (105), wherein one of the first and second terminal wells is configured to receive a left-bicuspid of the patient, and wherein the other of the first and second terminal wells is configured to receive a right-bicuspid of the patient therein.

11. The oral orthotic device of claim 10, further comprising a first protuberance (106) and a second protuberance (107), the first protuberance being disposed adjacent to the first terminal well, and the second protuberance being disposed adjacent to the second terminal well.

12. The oral orthotic device of claim 11, wherein the first and second protuberances are configured to concurrently touch opposing bicuspids on each of the left and right sides of the patient's bite upon occlusion.

13. The oral orthotic device of claim 1, wherein the oral orthotic device is configured to receive and nest maxillary teeth of the patient.

14. The oral orthotic device of claim 1, wherein the oral orthotic device is configured to receive and nest mandibular teeth of the patient.

15. (canceled)

16. An oral orthotic device (300), comprising:
a shell portion shaped to form a teeth-receiving cavity and an occlusal surface opposite the teeth-receiving cavity, wherein the teeth-receiving cavity is configured to receive and nest teeth of a patient;
characterized in that the oral orthotic device further comprises:
a first protuberance extending from the occlusal surface adjacent to a left-bicuspid, and
a second protuberance extending from the occlusal surface adjacent to a right-bicuspid;
wherein each of the first and second protuberances are configured to concurrently touch an opposing bicuspid upon occlusion of the patient's bite.

17. A method for treating complications of the masticatory neuromusculature, comprising:
providing an oral orthotic device configured to receive one or more left- and right-bicuspids of a patient and up to all of the patient's anterior teeth; or
providing an oral orthotic device configured to receive one or more left- and right-bicuspids of the patient and up to all of the patient's teeth (possibly including molars), wherein the oral orthotic device further comprises first and second protuberances, one of the first and second protuberances configured for positioning between the patient's upper and lower left-bicuspids on occlusion, and another of the first and second protuberances is configured for positioning between the patient's upper and lower right-bicuspids on occlusion; and
instructing the patient to wear the oral orthotic device.
